(19) United States
(12) Patent Application Publication
(10) Pub. No.: US 2026/0367344 A1
(43) Pub. Date: Nov. 19, 2026

(54) PLUGGABLE OPTICAL MODULE CONNECTOR ASSEMBLIES AND METHODS

(71) Applicant: Ciena Corporation, Hanover, MD (US)

(72) Inventors: Arkadiusz Lutkiewicz, Ottawa (CA); Marko Antonic, Almonte (CA); Georges Turcotte, Ottawa (CA)

(21) Appl. No.: 19/209,955

(22) Filed: May 16, 2025

(51) Int. Cl. G02B 6/42; H01R 12/72; H01R 12/73; H01R 13/502

(52) U.S. Cl. CPC G02B 6/4278; G02B 6/428; H01R 12/721; H01R 12/73; H01R 13/502

(57) ABSTRACT

A pluggable module including a body, a connector printed circuit board disposed at an end of the body and adapted to engage a connector of a host module, a plurality of standard-compliant signal traces or pads disposed at an outboard end of the connector printed circuit board, away from the body, a plurality of additional signal traces or pads disposed on the connector printed circuit board longitudinally inboard of the plurality of standard-compliant signal traces or pads disposed at the outboard end of the connector printed circuit board, towards the body, and a connector cover coupled to the body and disposed adjacent to the connector printed circuit board, where the connector cover defines a plurality of vent ports coincident with the plurality of additional signal traces or pads and providing access to the plurality of additional signal traces or pads through the connector cover.

### TECHNICAL FIELD

The present disclosure relates generally to the telecommunications and networking fields. More particularly, the present disclosure relates to pluggable optical module (POM) connector assemblies and methods for providing enhanced connector contact access for testing and product operation.

### BACKGROUND

Telecommunications and networking modules and the POMs received in cages of these host modules make use of multi-source agreement (MSA)-compliant pins and traces to make the associated connections between the host modules and POMs. These pins and traces are typically configured for product operation. Adding testing, debugging, and initial programming access to a POM often requires POM disassembly to reach internal test pads, which requires a skilled operator and is time-consuming and costly. Further, in a factory environment, this may require the use of complicated test jigs, open POMs cannot be tested in a mission mode due to mechanical and thermal limitations, and there is a high risk of optical fiber damage when handling an open POM. Testing, debugging, and initial programming access may also be provided by multiplexing test signals onto defined MSA-compliant pins and traces, which requires additional POM printed circuit board (PCB), as well as host module PCB, resources.

Further, the MSA-defined interconnects and any additional connectors provided for dongles typically provide insufficient connectivity to expose the signals needed for testing, debugging, and initial programming. For example, dual-purposing an existing MSA-defined interconnect as a testing, debugging, or initial programming interface for factory or laboratory use pushes significant complexity on the POM application-specific integrated circuit (ASIC), as well as the host module, which has to support the multiplexing of different protocols onto the same interconnect. Further, these testing and debugging functions may be lost in customer systems. In some systems, no spare interconnects are provided and one must resort to coupling the high-speed interfaces needed in the factory environment onto existing signals at great design risk and complexity. Additional interfaces cannot be accessed or exposed without adding additional connectors or opening the POM, and, again, the high-speed interfaces are not available in customer systems for the testing and debugging of the POM. Current POM designs are extremely dense and adding additional connectors is typically impossible or impractical. As a result, the signals that cannot fit onto the MSA-defined interconnects are only available on the internal test pads which require the POM to be disassembled to access. In the factory environment, this requires the use of complicated test jigs with pogo pins to access a limited number of signals.

The present background is provided as illustrative environmental context only and should not be construed to be limiting in any manner. It will be readily apparent to those of ordinary skill in the art that the principles and concepts of the present disclosure may be implemented in other environmental contexts equally, without limitation, such as for any type of pluggable module interconnecting with any type of module in any type of system.

### SUMMARY

The present disclosure provides POM connector assemblies and methods for providing enhanced connector contact access for testing, debugging, initial programming, and product operation. With the addition of such access to fully-assembled POMs, a factory or laboratory can program and test a POM in one operational step, without the need to move the POM from host module to host module or open the POM to perform different tasks.

Further, by making enhanced use of the interconnects that a POM already has, many more signals can be exposed in the factory environment, without adding the additional cost of multiplexing, additional connectors, or complexity to the ASIC and the product. The standard use of the POM is unaffected, and the signals can be exposed in a customer system by using an adapter jig that allows for depth-controlled POM insertion to breakout testing, debugging, and initial programming signals, for example. It will be readily apparent to those of ordinary skill in the art that the concepts and principles of the present disclosure are not only applicable to POMs, but may be applied to any pluggable modules (PMs). Accordingly, as used, POM and PM are interchangeable.

In some embodiments, the present disclosure provides a pluggable module including a body, a connector printed circuit board disposed at an end of the body and adapted to engage a connector of a host module, a plurality of standard-compliant signal traces or pads disposed at an outboard end of the connector printed circuit board, away from the body, a plurality of additional signal traces or pads disposed on the connector printed circuit board longitudinally inboard of the plurality of standard-compliant signal traces or pads disposed at the outboard end of the connector printed circuit board, towards the body, or disposed on a side of the connector printed circuit board opposite the plurality of standard-compliant signal traces or pads, and a connector cover coupled to the body and disposed adjacent to the connector printed circuit board, where the connector cover defines a plurality of vent ports coincident with the plurality of additional signal traces or pads and providing access to the plurality of additional signal traces or pads through the connector cover. The plurality of additional signal traces or pads are adapted to provide electrical contacts for testing, debugging, programming, or operating the pluggable module when the pluggable module is in a fully-assembled configuration. The plurality of additional signal traces or pads are also adapted to provide electrical contacts for testing, debugging, programming, or operating the pluggable module when the pluggable module is engaged with the connector of the host module. The plurality of vent ports defined by the connector cover are adapted to receive a plurality of protrusions of a testing/programming connector assembly disposed adjacent to the connector cover opposite the connector printed circuit board. In some embodiments, the plurality of vent ports defined by the connector cover and the plurality of protrusions of the testing/programming connector assembly are correspondingly keyed to mechanically align the testing/programming connector assembly with the pluggable module. The plurality of protrusions of the testing/programming connector assembly include a plurality of contacts adapted to make electrical contact with the plurality of additional signal traces or pads of the pluggable module. In some embodiments, the plurality of protrusions of the testing/programming connector assembly are biased towards the connector cover and the connector printed circuit board of the pluggable module. In some embodiments, the testing/programming connector assembly is coupled to the host module. In some embodiments, the plurality of additional signal traces or pads disposed on the connector printed circuit board longitudinally inboard of the plurality of standard-compliant signal traces or pads disposed at the outboard end of the connector printed circuit board, towards the body, or disposed on the side of the connector printed circuit board opposite the plurality of standard-compliant signal traces or pads include at least one row of additional signal traces or pads disposed on the connector printed circuit board longitudinally inboard of the plurality of standard-compliant signal traces or pads disposed at the outboard end of the connector printed circuit board, towards the body, or disposed on the side of the connector printed circuit board opposite the plurality of standard-compliant signal traces or pads. In some embodiments, the pluggable module further includes a plurality of additional signal traces or pads disposed on the connector printed circuit board longitudinally inboard of the plurality of additional standard-compliant signal traces, towards the body. The connector of the host module is adapted to make electrical contact with one or more of the plurality of standard-compliant signal traces or pads disposed at the outboard end of the connector printed circuit board, away from the body, the plurality of additional signal traces or pads disposed on the connector printed circuit board longitudinally inboard of the plurality of standard-compliant signal traces or pads disposed at the outboard end of the connector printed circuit board, towards the body, the plurality of additional standard-compliant signal traces or pads disposed on the connector printed circuit board longitudinally inboard of the plurality of additional signal traces or pads, towards the body, and the plurality of additional signal traces or pads disposed on the connector printed circuit board longitudinally inboard of the plurality of additional standard-compliant signal traces, towards the body, when the connector printed circuit board of the pluggable module is engaged with the connector of the host module.

In some embodiments, the present disclosure provides a pluggable module including a body, a connector printed circuit board disposed at an end of the body and adapted to engage a connector of a host module, a plurality of standard-compliant signal traces or pads disposed at an outboard end of the connector printed circuit board, away from the body, a plurality of additional signal traces or pads disposed on the connector printed circuit board longitudinally inboard of the plurality of standard-compliant signal traces or pads disposed at the outboard end of the connector printed circuit board, towards the body, and a plurality of additional standard-compliant signal traces or pads disposed on the connector printed circuit board longitudinally inboard of the plurality of additional signal traces or pads, towards the body. In some embodiments, the plurality of additional signal traces or pads disposed on the connector printed circuit board longitudinally inboard of the plurality of standard-compliant signal traces or pads disposed at the outboard end of the connector printed circuit board, towards the body, include at least one row of additional signal traces or pads disposed on the connector printed circuit board longitudinally inboard of the plurality of standard-compliant signal traces or pads disposed at the outboard end of the connector printed circuit board, towards the body. In some embodiments, the pluggable module also includes a plurality of additional signal traces or pads disposed on the connector printed circuit board longitudinally inboard of the plurality of additional standard-compliant signal traces, towards the body. The connector of the host module is adapted to make electrical contact with one or more of the plurality of standard-compliant signal traces or pads disposed at the outboard end of the connector printed circuit board, away from the body, the plurality of additional signal traces or pads disposed on the connector printed circuit board longitudinally inboard of the plurality of standard-compliant signal traces or pads disposed at the outboard end of the connector printed circuit board, towards the body, the plurality of additional standard-compliant signal traces or pads disposed on the connector printed circuit board longitudinally inboard of the plurality of additional signal traces or pads, towards the body, and the plurality of additional signal traces or pads disposed on the connector printed circuit board longitudinally inboard of the plurality of additional standard-compliant signal traces, towards the body, when the connector printed circuit board of the pluggable module is engaged with the connector of the host module.

In some embodiments, the present disclosure provides a pluggable module testing/programming connector assembly including a pluggable module including a body, a connector printed circuit board disposed at an end of the body and adapted to engage a connector of a host module, a plurality of standard-compliant signal traces or pads disposed at an outboard end of the connector printed circuit board, away from the body, a plurality of additional signal traces or pads disposed on the connector printed circuit board longitudinally inboard of the plurality of standard-compliant signal traces or pads disposed at the outboard end of the connector printed circuit board, towards the body, or disposed on a side of the connector printed circuit board opposite the plurality of standard-compliant signal traces or pads, and a connector cover coupled to the body and disposed adjacent to the connector printed circuit board, where the connector cover defines a plurality of vent ports coincident with the plurality of additional signal traces or pads and providing access to the plurality of additional signal traces or pads through the connector cover, and a testing/programming connector assembly including a base disposed adjacent to the connector cover opposite the connector printed circuit board, and a plurality of protrusions extending from the base through the plurality of vent ports defined by the connector cover, where the plurality of protrusions extending from the base include a plurality of contacts adapted to make electrical contact with the plurality of additional signal traces or pads of the pluggable module for testing, debugging, programming, or operating the pluggable module when the pluggable module is in a fully-assembled configuration. The plurality of contacts of the plurality of protrusions extending from the base are adapted to make electrical contact with the plurality of additional signal traces or pads of the pluggable module for testing, debugging, programming, or operating the pluggable module when the pluggable module is engaged with the connector of the host module. In some embodiments, the base of the testing/programming connector assembly is adapted to be nested within a conformal recess defined by the connector cover of the pluggable module. The pluggable module is adapted to be received within a cage coupled to a printed circuit board of the host module, and where the cage defines an opening adapted to provide electrical access to the testing/programming connector assembly through the cage.

It will be readily apparent to those of ordinary skill in the art that aspects and features of the described embodiments may be included, omitted, or combined as desired in a given application, without limitation.

### BRIEF DESCRIPTION OF THE DRAWINGS

The present disclosure is illustrated and described with reference to the various drawings, in which like reference numbers are used to denote like assembly components/method steps, as appropriate.

FIG. 1 illustrates an embodiment of the POM and the auxiliary pad access POM connector assembly of the present disclosure.

FIG. 2 illustrates an embodiment of the POM and the auxiliary pad access POM connector assembly of the present disclosure coupled to an associated host module and host module connector assembly and accessed by an associated testing/programming connector assembly.

FIG. 3 illustrates an embodiment of the testing/programming connector assembly of the present disclosure.

FIG. 4 illustrates an embodiment of the testing/programming connector assembly of the present disclosure engaging the POM and the auxiliary pad access POM connector assembly of the present disclosure.

FIG. 5 also illustrates an embodiment of the POM and the auxiliary pad access POM connector assembly of the present disclosure coupled to an associated host module and accessed by an associated testing/programming connector assembly.

FIG. 6 further illustrates an embodiment of the POM and the auxiliary pad access POM connector assembly of the present disclosure coupled to an associated host module and accessed by an associated testing/programming connector assembly.

FIG. 7 illustrates a conventional embodiment of a MSA-defined POM connector assembly and host module and host module connector assembly.

FIG. 8 illustrates a conventional embodiment of a MSA-defined POM connector assembly and host module and host module connector assembly in an interconnected configuration.

FIG. 9 illustrates an embodiment of the POM connector assembly and host module and host module connector assembly of the present disclosure.

FIG. 10 illustrates an embodiment of the POM connector assembly and host module and host module connector assembly of the present disclosure in a first interconnected configuration.

FIG. 11 illustrates an embodiment of the POM connector assembly and host module and host module connector assembly of the present disclosure in a second interconnected configuration.

FIG. 12 illustrates an embodiment of the POM connector assembly and host module and host module connector assembly of the present disclosure in a third interconnected configuration.

It will be readily apparent to those of ordinary skill in the art that aspects and features of the illustrated embodiments may be included, omitted, or combined as desired in a given application, without limitation.

### DETAILED DESCRIPTION

Again, the present disclosure provides POM connector assemblies and methods for providing enhanced connector contact access for testing, debugging, initial programming, and product operation. With the addition of such access to fully-assembled POMs, a factory or laboratory can program and test a POM in one operational step, without the need to move the POM from host module to host module or open the POM to perform different tasks.

Further, by making enhanced use of the interconnects that a POM already has, many more signals can be exposed in the factory environment, without adding the additional cost of multiplexing, additional connectors, or complexity to the ASIC and the product. The standard use of the POM is unaffected, and the signals can be exposed in a customer system by using an adapter jig that allows for depth-controlled POM insertion to breakout testing, debugging, and initial programming signals, for example. Again, it will be readily apparent to those of ordinary skill in the art that the concepts and principles of the present disclosure are not only applicable to POMs, but may be applied to any PMs. Accordingly, as used, POM and PM are interchangeable.

MSA-defined POMs must follow strict mechanical enclosure design specifications and predetermined connector pin/trace assignments for compatibility and interoperability purposes. Any deviation from the prescribed MSA document may result in MSA non-compliance. The present disclosure addresses MSA-defined POMs and connectors in the context of POMs such as SFFs, QSFPs, OSFPs, and other comparable connectorized systems with closed mechanical designs and connector pinouts.

Factory programming, as well as testing, debugging, and product operation may require signals to be accessed that cannot be given current MSA constraints. This means that significant constraints are placed on testing, debugging, initial programming, and product operation activities for fully-assembled POMs.

The present disclosure provides an enhanced host module assembly incorporating a testing/programming connector assembly that is designed to interconnect with the POM and auxiliary pad access POM connector assembly of the present disclosure. The fully-assembled POM retains all of its mechanical, electrical, and thermal compliance during testing, debugging, and initial programming.

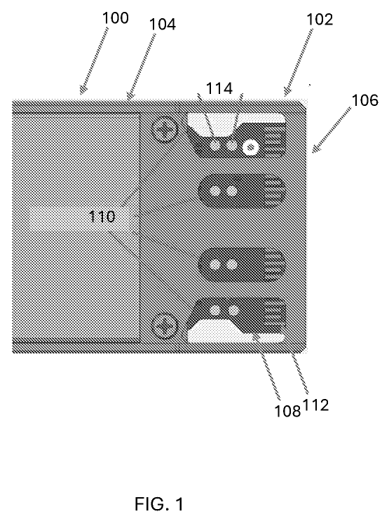

FIG. 1 illustrates an embodiment of the POM 100 and the auxiliary pad access POM connector assembly 102 of the present disclosure. The POM 100 includes a POM body 104 and a POM connector cover 106 that forms a portion of the POM body 104 and covers a POM connector PCB 108 disposed at the rear of the POM body 104, where the POM 100 interconnects with the associated host module connector assembly of the host module. The POM connector cover 106 defines a plurality of vent ports 110 that are partially coincident with and provide airflow to a plurality of signal traces (or pads) 112 provided on the POM connector PCB 108. In accordance with the present disclosure, a plurality of testing/programming signal pads (or traces) 114 are provided on the POM connector PCB 108 inboard of the plurality of signal traces (or pads) 112 relative to the POM body 104. These testing/programming signal pads (or traces) 114 are also coincident with the vent ports 110 of the POM connector cover 106 and are accessible through the vent ports 110 of the POM connector cover 106 from the top (or bottom) of the POM 100. It is these testing/programming signal pads (or traces) 114 that provide enhanced signal access for testing, debugging, initial programming, and/or operation of the POM 100 when the POM is fully assembled and interconnected with the host module connector assembly of the host module. It will be readily apparent to those of ordinary skill in the art that any number and configuration of testing/programming signal pads (or traces) 114 may be provided and accessed. As illustrated, the POM connector cover 106 is disposed adjacent to a top surface of the POM connector PCB 108, and the plurality of testing/programming signal pads (or traces) 114 are provided on the top surface of the POM connector PCB 108 inboard of the plurality of signal traces (or pads) 112 relative to the POM body 104. The testing/programming signal pads (or traces) 114 are coincident with the vent ports 110 of the top POM connector cover 106 and are accessible through the vent ports 110 of the top POM connector cover 106 from the top of the POM 100. Alternatively, the POM connector cover 106 may be disposed adjacent to a bottom surface of the POM connector PCB 108, and the plurality of testing/programming signal pads (or traces) 114 may be provided on the bottom surface of the POM connector PCB 108, opposite the plurality of signal traces (or pads) 112 on the top side of the POM connector PCB 106. The testing/programming signal pads (or traces) 114 are then coincident with the vent ports 110 of the bottom POM connector cover 106 and are accessible through the vent ports 110 of the bottom POM connector cover 106 from the bottom of the POM 100.

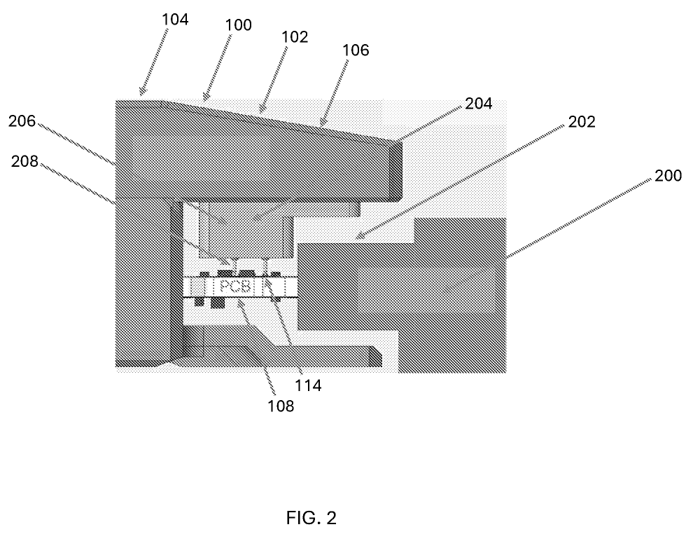

FIG. 2 illustrates an embodiment of the POM 100 and the auxiliary pad access POM connector assembly 102 of the present disclosure coupled to an associated host module 200 and host module connector assembly 202 and accessed by an associated testing/programming connector assembly 204. The testing/programming signal pads (or traces) 114 of the POM connector PCB 108 are accessed through the vent ports 110 when the signal traces (or pads) 112 of the POM connector PCB 108 are engaged with the host module connector assembly 202. This access is provided via multiple protruding structures 206 of the testing/programming connector assembly 204 that protrude through the vent ports 110 of the POM connector cover 106. These protruding structures 206 each include pins (or pads) 208 that contact the testing/programming signal pads (or traces) 114 of the POM connector PCB 108. The pins (or pads) 208 may be spring-loaded or otherwise biased into the testing/programming signal pads (or traces) 114 of the POM connector PCB 108. Likewise, the testing/programming connector assembly 204 and/or protruding structures 206 may be spring-loaded or otherwise biased into the testing/programming signal pads (or traces) 114 of the POM connector PCB 108. The testing/programming connector assembly 204 is mechanically aligned with the testing/programming signal pads (or traces) 114 of the POM connector PCB 108 using the vent ports 110 and may be a part of the host module 200 and host module connector assembly 202 or may be a separate assembly. The pins 208 may be replaced with other types of contacts or a connectorized interconnect in the event that high-speed signals are accessed, to meet reliability requirements for product operation.

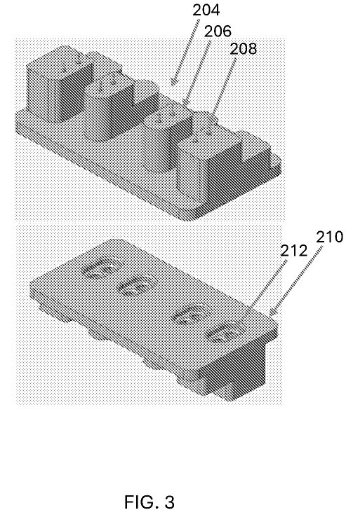

FIG. 3 illustrates an embodiment of the testing/programming connector assembly 204 of the present disclosure. The testing/programming connector assembly 204 includes the multiple protruding structures 206 that extend from a base 210 of the testing/programming connector assembly 204 through the vent ports 110 of the POM connector cover 106. These protruding structures 206 each include the pins (or pads) 208 that contact the testing/programming signal pads (or traces) 114 of the POM connector PCB 108. Again, the pins (or pads) 208 may be spring-loaded or otherwise biased into the testing/programming signal pads (or traces) 114 of the POM connector PCB 108. Likewise, the base 210 of the testing/programming connector assembly 204 and/or protruding structures 206 may be spring-loaded or otherwise biased into the testing/programming signal pads (or traces) 114 of the POM connector PCB 108. The testing/programming connector assembly 204 is mechanically aligned with the testing/programming signal pads (or traces) 114 of the POM connector PCB 108 using the vent ports 110 and may be a part of the host module 200 and host module connector assembly 202 or may be a separate assembly. The pins 208 may be replaced with other types of contacts or a connectorized interconnect in the event that high-speed signals are accessed, to meet reliability requirements for product operation. As is illustrated the protruding structures 206 and vent ports 110 are correspondingly shaped or keyed, such that the protruding structures 206 are conformally received and aligned within the vent ports 110. Testing, debugging, programming, or control systems are electrically coupled to the pins 208 via electrical contacts 212 provided through the body 210 of the testing/programming connector assembly 204 and the use of soldered wires, probes, pogo pins, etc.

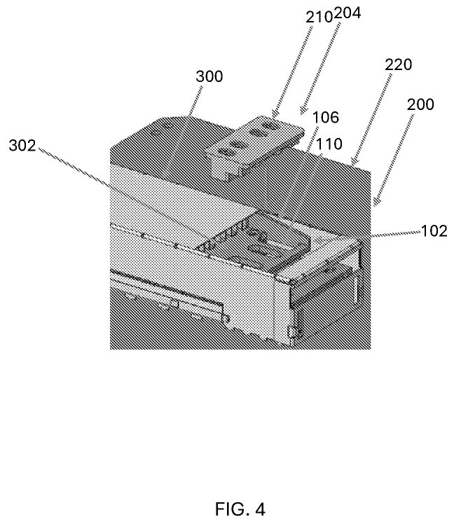

FIG. 4 illustrates an embodiment of the testing/programming connector assembly 204 of the present disclosure engaging the POM 100 and the auxiliary pad access POM connector assembly 102 of the present disclosure. The testing/programming connector assembly 204 engages the POM connector cover 106 and the vent ports 110 of the auxiliary pad access POM connector assembly 102 through an access opening 302 provided in a cage 300 in which the POM 100 is received on the surface of the host module PCB 220 of the host module 200. In addition to the protruding structures 206 engaging the vent ports 110, the base 210 of the testing/programming connector assembly 204 may also be conformally received within the POM connector cover 106. In a bottom access scenario, the host module PCB 220 may define appropriate openings for accessing the vent ports 110 of the bottom POM connector cover 106 and the bottom testing/programming signal pads (or traces) 114 of the POM connector PCB 108 through a bottom access opening 302 provided in the cage 300 in which the POM 100 is received.

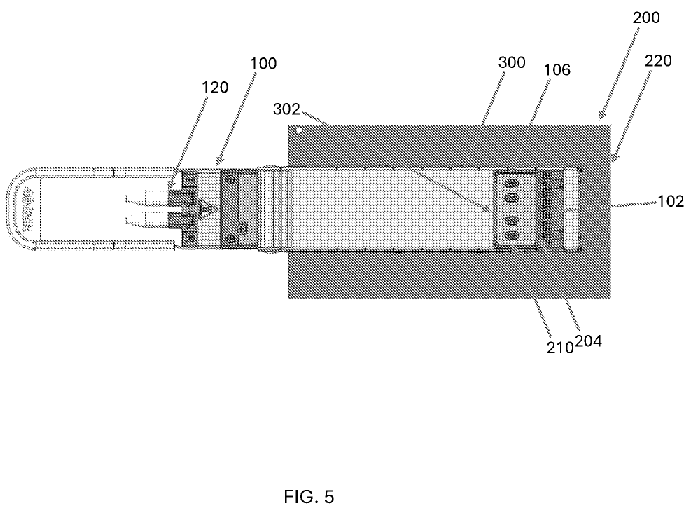

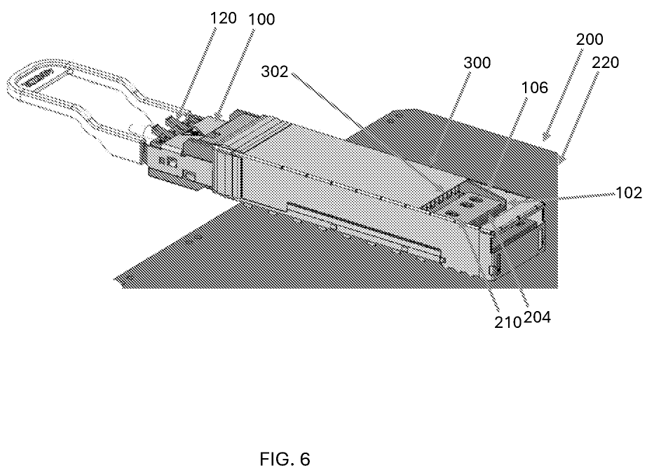

FIGS. 5 and 6 also illustrate an embodiment of the POM 100 and the auxiliary pad access POM connector assembly 102 of the present disclosure coupled to an associated host module 200 and accessed by an associated testing/programming connector assembly 204. Again, the testing/programming connector assembly 204 engages the POM connector cover 106 and the vent ports 110 of the auxiliary pad access POM connector assembly 102 through the access opening 302 provided in the cage 300 in which the POM 100 is received on the surface of the host module PCB 220 of the host module 200. In addition to the protruding structures 206 engaging the vent ports 110, the base 210 of the testing/programming connector assembly 204 may also be conformally received within the POM connector cover 106. In FIGS. 5 and 6, the optical connections 120 to the POM 100 are also illustrated.

The present disclosure also makes use of the interconnects that the POM already has, enabling access to many more signals in the factory environment without adding the additional cost of multiplexing, additional connectors, or complexity to the product and ASIC. The standard use case of the POM is unaffected, and the additional signals can be exposed in a customer system by using an adapter jig or the like that allows for the depth-controlled insertion of the POM into the cage, and the POM connector into the host module connector assembly to breakout the signals.

Again, the present disclosure is applicable to POMs, but is more generally applicable to any connectorized interface in which additional connections are made between existing contacts by controlling the connector insertion depth in a direction orthogonal to the direction of insertion. The interconnection between the POM and the host board is achieved by inserting the POM into a fixed connector on the host board. The precise dimensions and depth of this interconnection are dictated by MSA, such as SFF, QSFP, OSFP. Among the controlled dimensions is the depth of insertion of the POM paddle card or edge connector to ensure host pin-to-module pad connectivity. By modifying the depth of this insertion and adding additional pads to the interconnection, connectivity to pads beyond the MSA specification is achieved. The additional pads can make use of existing pre-wipe (i.e., no-connect) pads or be new pads to the interconnection entirely. MSA-compliant host connectivity is not affected as the additional pads are placed outside the specifications of the MSA, however special hosts which support multi-depth insertion can gain access to additional pads and signals using a standard and widely available MSA-defined host connector. The access to additional pads allows signals not needed for normal operation, but important for factory programming and testing, to be added which otherwise are not accommodated on the MSA connector pinout.

By controlling the board insertion depth into the host connector, an equivalent multi-pole, double-throw switch is constructed where one switch position at full-board insertion is for normal MSA-defined operation, and another position at partial-board insertion allows for custom factory modes where the POM is programmed and tested.

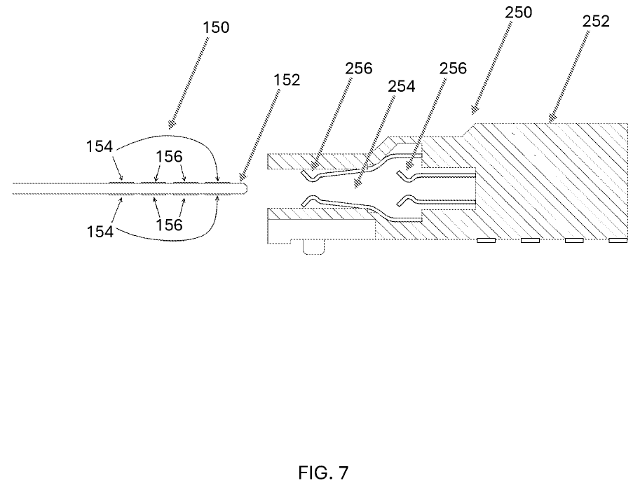

FIG. 7 illustrates a conventional embodiment of a MSA-defined POM connector assembly 150 and host module connector assembly 250. The POM connector assembly 150 includes a POM paddle card 152 (i.e., the POM PCB 108) that includes one or more inboard and outboard MSA-defined POM signal pads (or traces) 154 relative to the POM body 104 from forward to rearward. A plurality of pre-wipe (i.e., no-connect) pads 156 are disposed longitudinally between the inboard and outboard MSA-defined POM signal pads (or traces) 154. These pre-wipe pads 156 are undefined in that they are dummy pads that do not carry signals, serving primarily to protect the host module connector contacts 256 from abrasion on POM paddle card 152 insertion into/removal from the host module connector assembly 250. These may be copper pads or the like. The POM signal pads (or traces) 154 and pre-wipe pads 156 may be disposed on the top and/or bottom surfaces of the POM paddle card 152. The host module connector assembly 250 includes a host connector housing 252 defining a channel 254 in which the inserted POM paddle card 152 is received. A plurality of top and bottom contacts 256 are provided within the channel 254 and arranged to make contact with the POM signal pads (or traces) 154 disposed on the top and/or bottom surfaces of the POM paddle card 152 when the POM paddle card 152 is fully inserted into the channel 254 of the host connector housing 252. The outboard top and bottom contacts 256 relative to the host connector housing 252 temporarily make contact with the pre-wipe pads 156 as the POM paddle card 152 is inserted into the channel 254 of the host connector housing 252. The top and bottom contacts 256 make no contact with the pre-wipe pads 156 when the POM paddle card 152 is fully inserted into the channel 254 of the host connector housing 252.

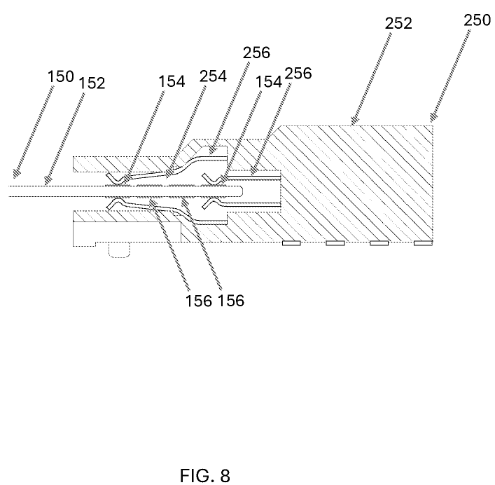

FIG. 8 illustrates a conventional embodiment of a MSA-defined POM connector assembly 150 and host module connector assembly 250 in an interconnected configuration. Here, the top and bottom contacts 256 of the host connector housing 252 make contact with the POM signal pads (or traces) 154 when the POM paddle card 152 is fully inserted into the channel 254 of the host connector housing 252. The top and bottom contacts 256 make no contact with the pre-wipe pads 156 when the POM paddle card 152 is fully inserted into the channel 254 of the host connector housing 252.

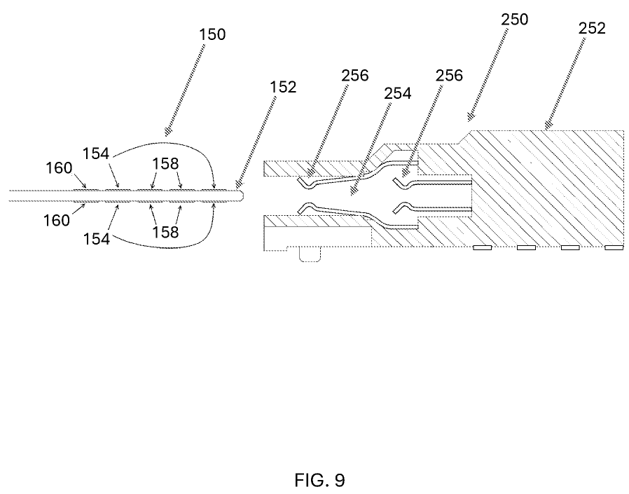

FIG. 9 illustrates an embodiment of the POM connector assembly 150 and host module connector assembly 250 of the present disclosure. The POM connector assembly 150 includes the POM paddle card 152 (i.e., the POM PCB 108) that includes one or more inboard and outboard MSA-defined POM signal pads (or traces) 154 relative to the POM body 104 from forward to rearward. In this embodiment, the plurality of pre-wipe (i.e., no-connect) pads 156 replaced with additional POM signal pads (or traces) 158 that are disposed longitudinally between the inboard and outboard MSA-defined POM signal pads (or traces) 154. Further, additional POM signal pads (or traces) 160 are disposed inboard of the inboard MSA-defined POM signal pads (or traces) 154. The POM signal pads (or traces) 154 and additional POM signal pads (or traces) 158, 160 may be disposed on the top and/or bottom surfaces of the POM paddle card 152. The host module connector assembly 250 includes the host connector housing 252 defining the channel 254 in which the inserted POM paddle card 152 is received. The plurality of top and bottom contacts 256 are provided within the channel 254 and arranged to selectively make contact with the POM signal pads (or traces) 154 and additional POM signal pads (or traces) 158, 160 disposed on the top and/or bottom surfaces of the POM paddle card 152 depending on the degree of insertion of the POM paddle card 152 into the channel 254 of the host connector housing 252. The outboard top and bottom contacts 256 relative to the host connector housing 252 temporarily make contact with any intervening POM signal pads (or traces) 154, 158 as the POM paddle card 152 is inserted into the channel 254 of the host connector housing 252. The top and bottom contacts 256 make no contact with these additional POM signal pads (or traces) 154, 158 when the POM paddle card 152 is fully inserted into the channel 254 of the host connector housing 252. In this manner, a variety of contacts can be made using a MSA-compliant host module connector assembly 250 and an enhanced MSA-compliant POM connector assembly 150 including multiple additional contacts based on the degree of insertion of the POM paddle card 152, which may be enabled/constrained by mechanical means.

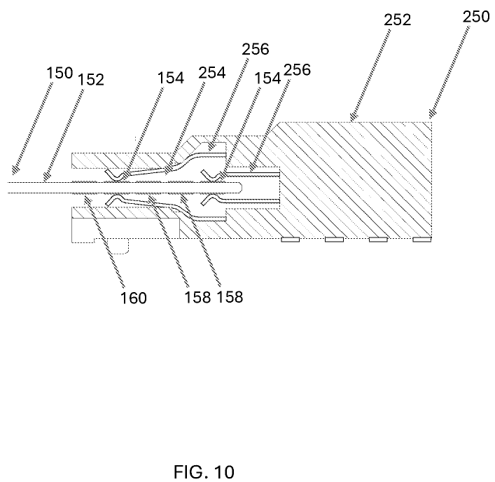

FIG. 10 illustrates an embodiment of the POM connector assembly 150 and host module connector assembly 250 of the present disclosure in a first interconnected configuration. When the POM paddle card 152 is fully inserted into the channel 254 of the host connector housing 252, the top and bottom contacts 256 engage the inboard and outboard MSA-defined POM signal pads (or traces) 154 in a conventional configuration. None of the additional POM signal pads (or traces) 158, 160 disposed on the top and/or bottom surfaces of the POM paddle card 152 are engaged by the contacts 256. The additional POM signal pads (or traces) 158 disposed on the top and/or bottom surfaces of the POM paddle card 152 act as pre-wipe pads as the POM paddle card 152 is fully inserted into the channel 254 of the host connector housing 252.

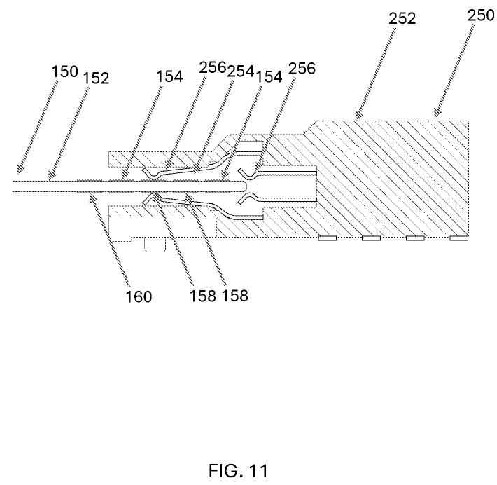

FIG. 11 illustrates an embodiment of the POM connector assembly 150 and host module connector assembly 250 of the present disclosure in a second interconnected configuration. When the POM paddle card 152 is fully inserted into the channel 254 of the host connector housing 252, the top and bottom contacts 256 engage the inboard additional POM signal pads (or traces) 158. None of the inboard or outboard MSA-defined POM signal pads (or traces) 154, outboard additional POM signal pads (or traces) 158, or inboard additional POM signal pads (or traces) 160 disposed on the top and/or bottom surfaces of the POM paddle card 152 are engaged by the contacts 256. The outboard additional POM signal pads (or traces) 158 disposed on the top and/or bottom surfaces of the POM paddle card 152 act as pre-wipe pads as the POM paddle card 152 is fully inserted into the channel 254 of the host connector housing 252. In this embodiment, only the outboard set of the contacts 256 are utilized, relative to the host module connector assembly 250, while the inboard set of the contacts 256 are not. Thus, full insertion is less or more shallow than in other embodiments.

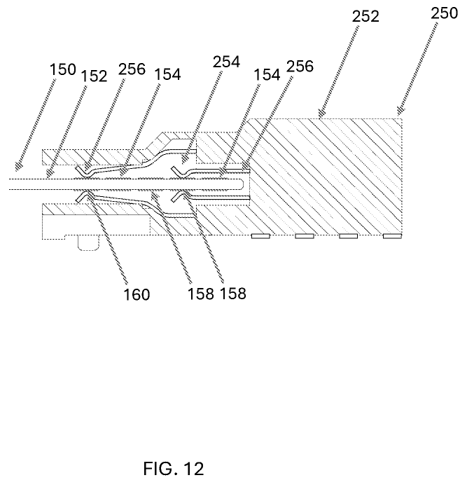

FIG. 12 illustrates an embodiment of the POM connector assembly 150 and host module connector assembly 250 of the present disclosure in a third interconnected configuration. When the POM paddle card 152 is fully inserted into the channel 254 of the host connector housing 252, the top and bottom contacts 256 engage the outboard additional POM signal pads (or traces) 158 and the additional POM signal pads (or traces) 160. None of the inboard or outboard MSA-defined POM signal pads (or traces) 154 or inboard additional POM signal pads (or traces) 158 disposed on the top and/or bottom surfaces of the POM paddle card 152 are engaged by the contacts 256. The inboard and outboard MSA-defined POM signal pads (or traces) 154 and inboard additional POM signal pads (or traces) 158 disposed on the top and/or bottom surfaces of the POM paddle card 152 act as pre-wipe pads as the POM paddle card 152 is fully inserted into the channel 254 of the host connector housing 252. In this embodiment, both the inboard and outboard sets of the contacts 256 are utilized, relative to the host module connector assembly 250 and full insertion is more or deeper than in other embodiments.

Although the present disclosure is illustrated and described with reference to specific embodiments and examples, it will be readily apparent to those of ordinary skill in the art that other embodiments and examples may perform similar functions and/or achieve like results. All such equivalent embodiments and examples are within the spirit and scope of the present disclosure, are contemplated, and are intended to be covered by the following non-limiting claims for all purposes.

What is claimed is:

1. A pluggable module comprising
a body,
a connector printed circuit board disposed at an end of the body and adapted to engage a connector of a host module,
a plurality of standard-compliant signal traces or pads disposed at an outboard end of the connector printed circuit board, away from the body,
a plurality of additional signal traces or pads disposed on the connector printed circuit board longitudinally inboard of the plurality of standard-compliant signal traces or pads disposed at the outboard end of the connector printed circuit board, towards the body, or disposed on a side of the connector printed circuit board opposite the plurality of standard-compliant signal traces or pads, and
a connector cover coupled to the body and disposed adjacent to the connector printed circuit board,
wherein the connector cover defines a plurality of vent ports coincident with the plurality of additional signal traces or pads and providing access to the plurality of additional signal traces or pads through the connector cover.

2. The pluggable module of claim 1, wherein the plurality of additional signal traces or pads are adapted to provide electrical contacts for testing, debugging, programming, or operating the pluggable module when the pluggable module is in a fully-assembled configuration.

3. The pluggable module of claim 1, wherein the plurality of additional signal traces or pads are adapted to provide electrical contacts for testing, debugging, programming, or operating the pluggable module when the pluggable module is engaged with the connector of the host module.

4. The pluggable module of claim 1, wherein the plurality of vent ports defined by the connector cover are adapted to receive a plurality of protrusions of a testing/programming connector assembly disposed adjacent to the connector cover opposite the connector printed circuit board.

5. The pluggable module of claim 4, wherein the plurality of vent ports defined by the connector cover and the plurality of protrusions of the testing/programming connector assembly are correspondingly keyed to mechanically align the testing/programming connector assembly with the pluggable module.

6. The pluggable module of claim 4, wherein the plurality of protrusions of the testing/programming connector assembly comprise a plurality of contacts adapted to make electrical contact with the plurality of additional signal traces or pads of the pluggable module.

7. The pluggable module of claim 4, wherein the plurality of protrusions of the testing/programming connector assembly are biased towards the connector cover and the connector printed circuit board of the pluggable module.

8. The pluggable module of claim 4, wherein the testing/programming connector assembly is coupled to the host module.

9. The pluggable module of claim 1, wherein the plurality of additional signal traces or pads disposed on the connector printed circuit board longitudinally inboard of the plurality of standard-compliant signal traces or pads disposed at the outboard end of the connector printed circuit board, towards the body, or disposed on the side of the connector printed circuit board opposite the plurality of standard-compliant signal traces or pads comprise at least one row of additional signal traces or pads disposed on the connector printed circuit board longitudinally inboard of the plurality of standard-compliant signal traces or pads disposed at the outboard end of the connector printed circuit board, towards the body, or disposed on the side of the connector printed circuit board opposite the plurality of standard-compliant signal traces or pads.

10. The pluggable module of claim 1, further comprising a plurality of additional standard-compliant signal traces or pads disposed on the connector printed circuit board longitudinally inboard of the plurality of additional signal traces or pads, towards the body.

11. The pluggable module of claim 10, further comprising a plurality of additional signal traces or pads disposed on the connector printed circuit board longitudinally inboard of the plurality of additional standard-compliant signal traces, towards the body.

12. The pluggable module of claim 11, wherein the connector of the host module is adapted to make electrical contact with one or more of the plurality of standard-compliant signal traces or pads disposed at the outboard end of the connector printed circuit board, away from the body, the plurality of additional signal traces or pads disposed on the connector printed circuit board longitudinally inboard of the plurality of standard-compliant signal traces or pads disposed at the outboard end of the connector printed circuit board, towards the body, the plurality of additional standard-compliant signal traces or pads disposed on the connector printed circuit board longitudinally inboard of the plurality of additional signal traces or pads, towards the body, and the plurality of additional signal traces or pads disposed on the connector printed circuit board longitudinally inboard of the plurality of additional standard-compliant signal traces, towards the body, when the connector printed circuit board of the pluggable module is engaged with the connector of the host module.

13. A pluggable module comprising
a body,
a connector printed circuit board disposed at an end of the body and adapted to engage a connector of a host module,
a plurality of standard-compliant signal traces or pads disposed at an outboard end of the connector printed circuit board, away from the body,
a plurality of additional signal traces or pads disposed on the connector printed circuit board longitudinally inboard of the plurality of standard-compliant signal traces or pads disposed at the outboard end of the connector printed circuit board, towards the body, and
a plurality of additional standard-compliant signal traces or pads disposed on the connector printed circuit board longitudinally inboard of the plurality of additional signal traces or pads, towards the body.

14. The pluggable module of claim 13, wherein the plurality of additional signal traces or pads disposed on the connector printed circuit board longitudinally inboard of the plurality of standard-compliant signal traces or pads disposed at the outboard end of the connector printed circuit board, towards the body, comprise at least one row of additional signal traces or pads disposed on the connector printed circuit board longitudinally inboard of the plurality of standard-compliant signal traces or pads disposed at the outboard end of the connector printed circuit board, towards the body.

15. The pluggable module of claim 13, further comprising a plurality of additional signal traces or pads disposed on the connector printed circuit board longitudinally inboard of the plurality of additional standard-compliant signal traces, towards the body.

16. The pluggable module of claim 15, wherein the connector of the host module is adapted to make electrical contact with one or more of the plurality of standard-compliant signal traces or pads disposed at the outboard end of the connector printed circuit board, away from the body, the plurality of additional signal traces or pads disposed on the connector printed circuit board longitudinally inboard of the plurality of standard-compliant signal traces or pads disposed at the outboard end of the connector printed circuit board, towards the body, the plurality of additional standard-compliant signal traces or pads disposed on the connector printed circuit board longitudinally inboard of the plurality of additional signal traces or pads, towards the body, and the plurality of additional signal traces or pads disposed on the connector printed circuit board longitudinally inboard of the plurality of additional standard-compliant signal traces, towards the body, when the connector printed circuit board of the pluggable module is engaged with the connector of the host module.

17. A pluggable module testing/programming connector assembly comprising
a pluggable module comprising
a body,
a connector printed circuit board disposed at an end of the body and adapted to engage a connector of a host module,
a plurality of standard-compliant signal traces or pads disposed at an outboard end of the connector printed circuit board, away from the body,
a plurality of additional signal traces or pads disposed on the connector printed circuit board longitudinally inboard of the plurality of standard-compliant signal traces or pads disposed at the outboard end of the connector printed circuit board, towards the body, or disposed on a side of the connector printed circuit board opposite the plurality of standard-compliant signal traces or pads, and
a connector cover coupled to the body and disposed adjacent to the connector printed circuit board,
wherein the connector cover defines a plurality of vent ports coincident with the plurality of additional signal traces or pads and providing access to the plurality of additional signal traces or pads through the connector cover, and
a testing/programming connector assembly comprising
a base disposed adjacent to the connector cover opposite the connector printed circuit board, and
a plurality of protrusions extending from the base through the plurality of vent ports defined by the connector cover,
wherein the plurality of protrusions extending from the base comprise a plurality of contacts adapted to make electrical contact with the plurality of additional signal traces or pads of the pluggable module for testing, debugging, programming, or operating the pluggable module when the pluggable module is in a fully-assembled configuration.

18. The pluggable module testing/programming connector assembly of claim 17, wherein the plurality of contacts of the plurality of protrusions extending from the base are adapted to make electrical contact with the plurality of additional signal traces or pads of the pluggable module for testing, debugging, programming, or operating the pluggable module when the pluggable module is engaged with the connector of the host module.

19. The pluggable module testing/programming connector assembly of claim 17, wherein the base of the testing/programming connector assembly is adapted to be nested within a conformal recess defined by the connector cover of the pluggable module.

20. The pluggable module testing/programming connector assembly of claim 17, wherein the pluggable module is adapted to be received within a cage coupled to a printed circuit board of the host module, and wherein the cage defines an opening adapted to provide electrical access to the testing/programming connector assembly through the cage.
